(19) United States
(12) Patent Application Publication
(10) Pub. No.: US 2008/0121186 A1
(43) Pub. Date: May 29, 2008

(54) Protective Enclosure for Hanging Wild Bird Feeders

(76) Inventor: Bertram Mindell, Middlesex (GB)

Correspondence Address: WHYTE HIRSCHBOECK DUDEK S C, 555 EAST WELLS STREET, SUITE 1900, MILWAUKEE, WI, 53202, US

(21) Appl. No.: 11/939,104

(22) Filed: Nov. 13, 2007

(30) Foreign Application Priority Data
Nov. 14, 2006 (GB) 0622626.0

(51) Int. Cl. A01K 39/00

(52) U.S. Cl. 119/52.3

(57) ABSTRACT

A protective enclosure (10) with releasable and replaceable base (7) or section of side (12) so that a wild bird feeder can be installed as a totally separate product from the enclosure.

It is quite common for a tube-shaped wild bird feeder to be incorporated in a structure where it is surrounded by a normally round mesh system whose purpose is to deny the access of various undesired intruders such as squirrels or pigeons to the bird food. Normally the feeder is connected in some manner to the surrounding mesh system and the feeder and mesh system are supplied as a single unit.

The disadvantage of such a product is that, since the bird feeder is an integral part of such a protective system, the customer has no choice in what is a most important element namely the size, quality and type of bird feeder supplied. It can also be difficult to remove the feeder from the protective mesh system for thorough cleaning. Furthermore it is difficult to include other birdfood products such as mealworms or suet blocks within the same protective system as the tube-shaped bird feeder.

It would therefore be helpful if the wild bird feeder and the mesh system were totally separate products so that the customer could choose between the variety of feeders available in the market. This can be achieved if the feeder is not fixed in any way to the protective mesh system and if access to the feeder is via the base or a portion of the side of the protective mesh system. It is also helpful if the access method allows the use of both hands when attending to the bird feeder

Accordingly the present invention provides a protective enclosure suitable for surrounding a wild bird feeder where access to arrange said wild bird feeder in said protective enclosure is accomplished by the whole of the base or a section of the side of said protective enclosure being connected to the adjacent area of the side of said protective enclosure by a securing system whereby said base or said section of said side can be regularly completely or partially detached from said section of said side and resecured to it with said wild bird feeder either being capable of hanging freely from a hook attached to the underside of the top of said protective enclosure where said protective enclosure is suspendable from an external support or by the hanger of said wild bird feeder being capable of projecting upwards through a slit in the top of said protective enclosure so that the top of said wild bird feeder supports the top of said protective enclosure where said hanger is suspendable from an external support.

Preferably said securing system comprises one or more hinges, clamps, rings or some other securing method in one location and a releasable arrangement in another, usually opposite, location.

Preferably said protective enclosure is made from a rigid or semi-rigid material such as metal.

Preferably the top and the base of said protective enclosure are made from solid metal or metal mesh with very small openings.

Preferably said base has small holes in it for water drainage purposes.

Preferably said base is shaped so that, when it is attached to the sides of said protective enclosure its centre is lower than its periphery. This assists water drainage and also simplifies the collection of dropped bird food.

Preferably said releasable arrangement, when released or undone, allows said base or said section of side to hang sufficiently away from the body of said protective enclosure to allow access to said bird tube feeder and also to fit with the rest of said protective enclosure when refastened Preferably said releasable arrangement comprises a bolt and nut, a self-tapping bolt, a retractable bolt or ring or any other system which allows the appropriate area to be regularly released from and subsequently attached to the main body of said protective enclosure.

Preferably, a ring or handle is situated approximately centrally on the top of the upper side of said protective enclosure to facilitate the suspension of said protective enclosure from an external support when said protective enclosure includes said hook.

Preferably said roof of said protective enclosure has a slit in it through which the hanger of a bird tube feeder can be projected from below when said protective enclosure does not include said hook and said ring or handle.

Preferably the sides of said protective enclosure form a cage structure comprising a matrix presenting generally rectangular orifices.

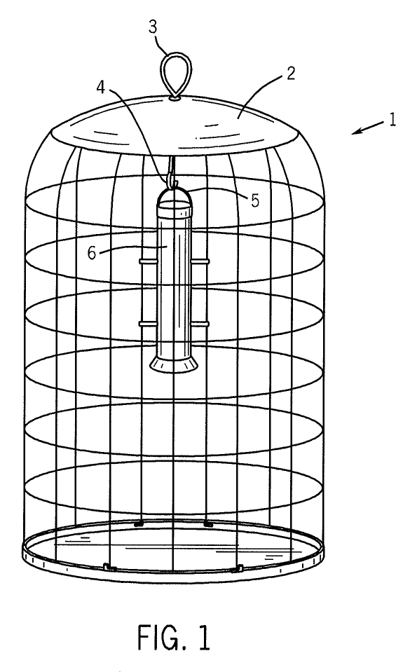

FIG. 1 is an elevation showing a protective enclosure for hanging a wild bird feeder with a hook attached to the underside of the top of the enclosure.

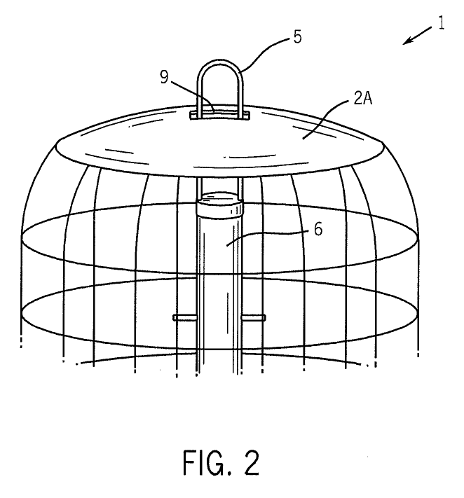

FIG. 2 is an elevation showing the top of a protective enclosure with a slit in it.

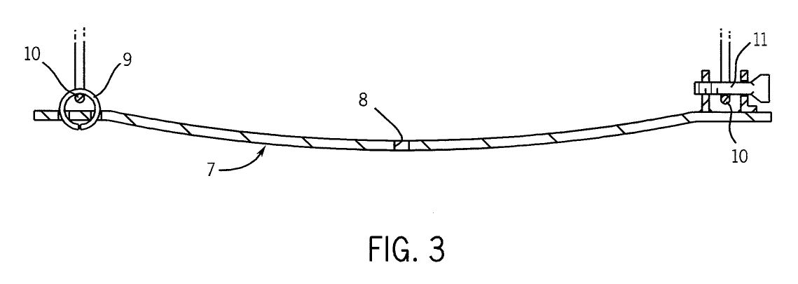

FIG. 3 shows the base of the protective enclosure illustrating one method whereby it can be removed and replaced in position.

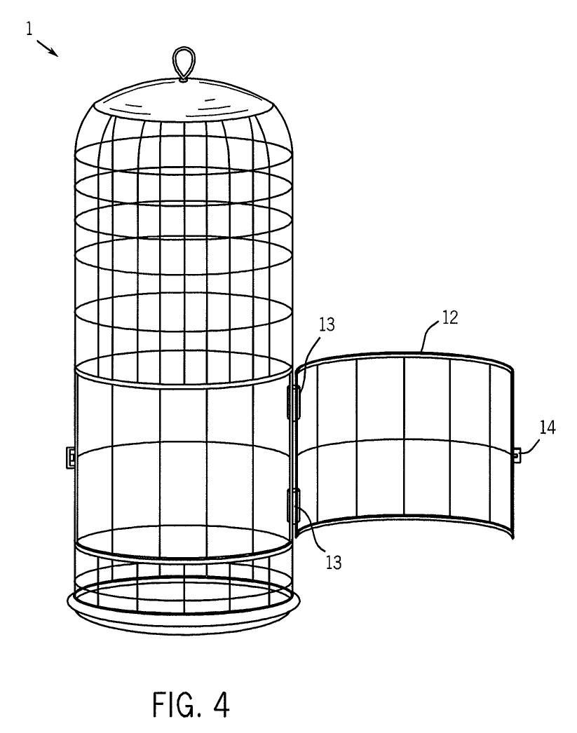

FIG. 4 show a protective enclosure where access is via the side.

### BRIEF DESCRIPTION OF THE DRAWINGS

In FIG. 1 the protective enclosure 1 is shown with a solid roof 2. A ring 3 is shown attached to the upper side of the roof and a hook 4 is shown attached to the lower side of the roof. The hanger 5 of a tube feeder is shown hanging from the hook.

In FIG. 2 the top part of the protective enclosure 1 is shown with a solid roof 2a which has a slit in it 9 through which the hanger 5 of a tube feeder for wild birds 6 is placed.

In FIG. 3 the base 7 with a drainage hole 8 is shown with a ring 9 attaching it to the bottom mesh of the side 10 with the other side of the base being secured to the bottom mesh by a releasable bolt and nut 11 as being one of the methods to attach the base in position.

In FIG. 4 a section of the side 12 is attached to the rest of the protective enclosure 1 by two hinges 13 and a releasable bolt and nut 14

1. A protective enclosure suitable for surrounding a wild bird feeder where access to arrange said wild bird feeder in said protective enclosure is accomplished by the whole of the base or a section of the side of said protective enclosure being connected to the adjacent area of the side of said protective enclosure by a securing system whereby said base or said section of said side can be regularly completely or partially detached from said section of said side and resecured to it with said wild bird feeder either being capable of hanging freely from a hook attached to the underside of the top of said protective enclosure where said protective enclosure is suspendable from an external support or by the hanger of said wild bird feeder being capable of projecting upwards through a slit in the top of said protective enclosure so that the top of said wild bird feeder supports the top of said protective enclosure where said hanger is suspendable from an external support.

2. A protective enclosure as claimed in claim 1 where said securing system comprises one or more hinges, clamps, rings or some other securing method in one location and a releasable arrangement in another, usually opposite, location.

3. A protective enclosure as claimed in any previous claim which is made from a rigid or semi-rigid material such as metal.

4. A protective enclosure as claimed in any previous claim whose base and top are made from solid metal or metal mesh with very small openings.

5. A protective enclosure as claimed in any previous claim whose base has small holes in it for water drainage purposes.

6. A protective enclosure as claimed in any previous claim the centre of whose base, when installed, is lower than its periphery.

7. A protective enclosure as claimed in any previous claim where said releasable arrangement comprises a bolt and nut, a self-tapping bolt, a retractable bolt or ring or any other system which allows the appropriate area to be regularly released from and subsequently attached to the main body of said protective enclosure.

8. A protective system as claimed in any previous claim where said releasable arrangement, when released or undone, allows said base or said section of side to hang sufficiently away from the body of said protective enclosure to allow access to said bird tube feeder and also to fit with the rest of said protective enclosure when refastened

9. A protective enclosure as claimed in any previous claim which has a ring or handle situated approximately centrally on the top of the upper side of said protective enclosure to facilitate the suspension of said protective enclosure from an external support when said protective enclosure includes said hook.

10. A protective enclosure as claimed in any previous claim which has a slit in its roof through which the hanger of a bird tube feeder can be projected from below when said protective enclosure does not include said hook and said ring or handle.

11. A protective enclosure as claimed in any previous claim whose sides form a cage structure comprising a matrix presenting generally rectangular orifices

12. An enclosure as claimed in any previous claim as described herein above with reference to FIGS. 1, 2, 3 and 4 of the accompanying drawings.
